(19) United States
(12) Patent Application Publication
(10) Pub. No.: US 2024/0389108 A1
(43) Pub. Date: Nov. 21, 2024

(54) Communication Apparatus and Method for Handling Multi-cell Scheduling

(71) Applicant: MEDIATEK INC., Hsin-Chu (TW)

(72) Inventor: Chi-Hsuan Hsieh, Hsinchu City (TW)

(73) Assignee: MEDIATEK INC., Hsin-Chu (TW)

(21) Appl. No.: 18/443,256

(22) Filed: Feb. 15, 2024

Related U.S. Application Data
(60) Provisional application No. 63/502,139, filed on May 15, 2023.

(51) Int. Cl. H04W 72/232; H04W 72/12

(52) U.S. Cl. CPC H04W 72/232; H04W 72/12

(57) ABSTRACT

A communication apparatus comprises a radio transceiver and a modem processor. The radio transceiver is configured to transmit or receive wireless signals to communicate with a network device. The modem processor is coupled to the radio transceiver and configured to perform operations comprising: receiving a downlink (DL) control information (DCI) from the network device, wherein the DCI comprises a common field with a minimum applicable scheduling offset indicator in response to a higher layer parameter being configured, and the DCI does not comprise the common field with the minimum applicable scheduling offset indicator in response to the higher layer parameter being not configured; and scheduling a plurality of cells for the communication apparatus according to the DCI.

### CROSS REFERENCE TO RELATED APPLICATIONS

This application claims the benefit of U.S. Provisional Application No. 63/502,139, filed on May 15, 2023. The content of the application is incorporated herein by reference.

### BACKGROUND

Long Term Evolution (LTE) is a set of enhancements to the Universal Mobile Telecommunications System (UMTS) mobile standard promulgated by 3rd generation partnership project (3GPP) for enabling high-speed packet communications. After LTE, 5G (fifth generation) New Radio (NR) is a new Radio Access Technology (RAT) developed by 3GPP for the 5G mobile network. The terminology 3GPP Radio Access Technology (RAT) may refer to the RAT promulgated or developed by 3GPP. The User Equipment (UE) is capable of communicating to the network device via the 3GPP RAT and/or the non-3GPP RAT (e.g., the WiFi or the wireless local access network (WLAN)) in the wireless network.

A downlink (DL) control information (DCI) carries control information used to schedule a cell communicating with the UE. Nowadays, the UE may camp on multiple cells simultaneously and co-schedule the multiple cells, which causes an increased control overhead of the UE and an increased decoding complexity for the DCI decoding. Thus, how to reduce the control overhead of the UE and the decoding complexity for the DCI decoding is an important problem to be solved.

### SUMMARY

It is an objective of the invention to provide a communication apparatus and a method for handling multi-cell scheduling, in order to solve the above problem.

An embodiment of the invention provides a communication apparatus comprising a radio transceiver and a modem processor. The radio transceiver is configured to transmit or receive wireless signals to communicate with a network device. The modem processor is coupled to the radio transceiver and configured to perform operations comprising: receiving a downlink (DL) control information (DCI) from the network device, wherein the DCI comprises a common field with a minimum applicable scheduling offset indicator in response to a higher layer parameter being configured, and the DCI does not comprise the common field with the minimum applicable scheduling offset indicator in response to the higher layer parameter being not configured; and scheduling a plurality of cells for the communication apparatus according to the DCI.

An embodiment of the invention provides a communication apparatus comprising a radio transceiver and a modem processor. The radio transceiver is configured to transmit or receive wireless signals to communicate with a network device. The modem processor is coupled to the radio transceiver and configured to perform operations comprising: receiving the a downlink (DL) control information (DCI) comprising a plurality of DCI fields and at least one padding value from the network device; and scheduling a plurality of cells for the communication apparatus according to the DCI.

A method for handling multi-cell scheduling comprises: receiving a downlink (DL) control information (DCI) from the network device, wherein the DCI comprises a common field with a minimum applicable scheduling offset indicator in response to a higher layer parameter being configured, and the DCI does not comprise the common field with the minimum applicable scheduling offset indicator in response to the higher layer parameter being not configured; and scheduling a plurality of cells for the communication apparatus according to the DCI.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exemplary block diagram of a communication apparatus according to an embodiment of the invention.

FIG. 2 is an exemplary block diagram of a modem according to an embodiment of the invention.

FIG. 3 is a flowchart of a process according to an embodiment of the invention.

FIG. 4 is a flowchart of a process according to an embodiment of the invention.

FIG. 5 is a schematic diagram of a DCI according to an embodiment of the invention.

FIG. 6 is a schematic diagram of a DCI according to an embodiment of the invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

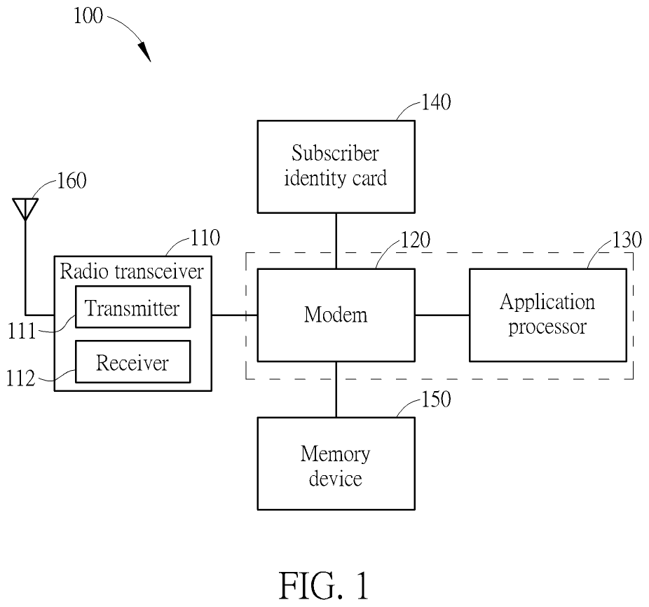

FIG. 1 is an exemplary block diagram of a communication apparatus 100 according to an embodiment of the invention. The communication apparatus 100 may be a portable electronic device, such as a Mobile Station (MS, which may be interchangeably referred to as User Equipment (UE)). The communication apparatus 100 may comprise at least an antenna module comprising a radio transceiver 110, a modem 120, an application processor 130, a subscriber identity card 140, a memory device 150 and at least one antenna 160. The radio transceiver 110 may be configured to transmit and/or receive wireless signals to and/or from a network device in a wireless network via the antenna module, so as to communicate with the network device via a communication link established between the communication apparatus 100 and the network device. The radio transceiver 110 may comprise a receiver 112 configured to receive wireless signals from the air interface and a transmitter 111 configured to transmit wireless signals to the air interface, and the radio transceiver 110 may be further configured to perform radio frequency (RF) signal processing. For example, the receiver 112 may convert the received signals into intermediate frequency (IF) or baseband signals to be processed, or the transmitter 111 may receive the IF or baseband signals from the modem 120 and convert the received signals into wireless signals to be transmitted to the network device in the wireless network or in an access network (e.g., a cellular network or a wireless local access network). According to an embodiment of the invention, the network device may be a cell, a Node-B (NB), an evolved Node-B (eNB), a g Node-B (gNB), a base station, a Mobility Management Entity (MME), an Access and Mobility Management Function (AMF) device, an Access Point (AP), etc., at the network side and communicating with the communication apparatus 100 by the wireless signals via the communication link.

The transmitter 111 and the receiver 112 of the radio transceiver 110 may comprise a plurality of hardware devices to perform RF conversion and RF signal processing. For example, the transmitter 111 and/or the receiver 112 may comprise a power amplifier for amplifying the RF signals, a filter for filtering unwanted portions of the RF signals and/or a mixer for performing radio frequency conversion. According to an embodiment of the invention, the radio frequency may be, for example, the frequency of any specific frequency band for a LTE system, the frequency of any specific frequency band for a 5G NR system, or the frequency of any specific frequency band for a WiFi system, etc.

The modem 120 may be configured to handle corresponding communications protocol operations and processing the IF or baseband signals received from or to be transmitted to the radio transceiver 110. The application processor 130 is configured to run the operating system of the communication apparatus 100 and run application programs installed in the communication apparatus 100. In the embodiments of the invention, the modem 120 and the application processor 130 may be designed as discrete chips with some buses or hardware interfaces coupled therebetween, or they may be integrated into a combo chip (i.e., a system on chip (SoC)), and the invention should not be limited thereto.

The subscriber identity card 140 may be a subscriber identity module (SIM), universal mobile telecommunications system (UMTS) SIM (USIM), removable user identity module (R-UIM) or code division multiple access (CDMA) SIM (CSIM) card, or the like and may typically contain user account information, an International Mobile Subscriber Identity (IMSI) and a set of SIM application toolkit (SAT) commands and may provide storage space for phone book contacts. The memory device 150 may be coupled to the modem 120 and application processor 130 and may store system data or user data.

It should be noted that, in order to clarify the concept of the invention, FIG. 1 presents a simplified block diagram in which only the elements relevant to the invention are shown. For example, in some embodiments of the invention, the communication apparatus may further comprise some peripheral devices not shown in FIG. 1. In another example, in some embodiments of the invention, the communication apparatus may further comprise a central controller coupled to the modem 120 and the application processor 130. Therefore, the invention should not be limited to what is shown in FIG. 1.

In some embodiments of the invention, the communication apparatus is capable of supporting multiple radio access technologies (RATs) communications via the single-card structure as shown in FIG. 1. It should be noted that, although FIG. 1 shows a single-card application, the invention should not be limited thereto. For example, in some embodiments of the invention, the communication apparatus may comprise multiple subscriber identity cards to support the multi-RATs communications, in either a single-standby or a multiple-standby manner. In the multi-RATs communications applications, the modem, the radio transceiver and/or the antenna module may be shared by the subscriber identity card(s) and may have the capability of handling the operations of different RATs and processing the corresponding RF, IF or baseband signals in compliance with the corresponding communications protocols.

In addition, those who are skilled in this technology can still make various alterations and modifications based on the descriptions given above to derive the communication apparatuses comprising multiple radio transceivers and/or multiple antenna modules for supporting multi-RAT wireless communications without departing from the scope and spirit of this invention. Therefore, in some embodiments of the invention, the communication apparatus may be designed to support a multi-card application, in either a single-standby or a multiple-standby manner, by making some alterations and modifications.

It should be further noted that the subscriber identity card 140 may be dedicated hardware cards as described above, or in some embodiments of the invention, there may be virtual cards, such as individual identifiers, numbers, addresses, or the like which are burned in the internal memory device of the corresponding modem and are capable of identifying the communication apparatus. Therefore, the invention should not be limited to what is shown in the figures.

It should be further noted that in some embodiments of the invention, the communication apparatus may further support multiple IMSIs.

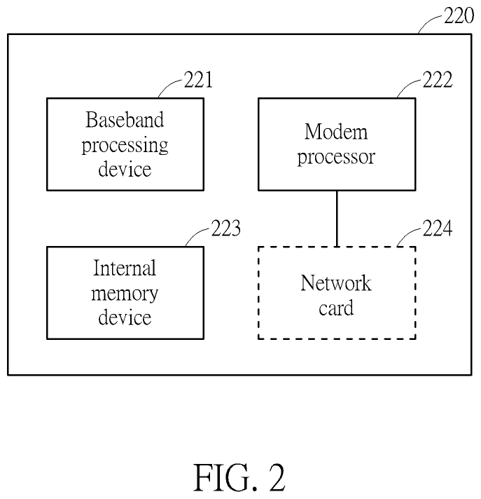

FIG. 2 is an exemplary block diagram of a modem 220 according to an embodiment of the invention. The modem 220 may be the modem 120 shown in FIG. 1 and may comprise at least a baseband processing device 221, a processor 222 (to discriminate from the “application processor” shown in FIG. 1, hereinafter named the “modem processor”), an internal memory device 223 and a network card 224. The baseband processing device 221 may receive the IF or baseband signals from the radio transceiver 110 and perform IF or baseband signal processing. For example, the baseband processing device 221 may convert the IF or baseband signals into a plurality of digital signals, and process the digital signals, and vice versa. The baseband processing device 221 may comprise a plurality of hardware devices to perform signal processing, such as an analog-to-digital converter for ADC conversion, a digital-to-analog converter for DAC conversion, an amplifier for gain adjustment, a modulator for signal modulation, a demodulator for signal demodulation, an encoder for signal encoding, a decoder for signal decoding, and so on.

According to an embodiment of the invention, the baseband processing device 221 may be designed to have the capability of handling the baseband signal processing operations for different RATs and processing the corresponding IF or baseband signals in compliance with the corresponding communications protocols, so as to support the multi-RAT wireless communications. According to another embodiment of the invention, the baseband processing device 221 may comprise a plurality of sub-units, each being designed to have the capability of handling the baseband signal processing operations of one or more specific RATs and processing the corresponding IF or baseband signals in compliance with the corresponding communications protocols, so as to support the multi-RAT wireless communications. Therefore, the invention should not be limited to any specific way of implementation.

The modem processor 222 may control the operations of the modem 220. According to an embodiment of the invention, the modem processor 222 may be arranged to execute the program codes of the corresponding software module of the modem 220. The modem processor 222 may maintain and execute the individual tasks, threads, and/or protocol stacks for different software modules. In an embodiment, a protocol stack may be implemented so as to respectively handle the radio activities of one RAT. However, it is also possible to implement more than one protocol stack to handle the radio activities of one RAT at the same time, or implement only one protocol stack to handle the radio activities of more than one RAT at the same time, and the invention should not be limited thereto.

The modem processor 222 may also read data from the subscriber identity card coupled to the modem, such as the subscriber identity card 140, and write data to the subscriber identity card. The internal memory device 223 may store system data and user data for the modem 220. The modem processor 222 may also access the internal memory device 223.

The network card 224 provides Internet access services for the communication apparatus. It should be noted that, although the network card 224 shown in FIG. 2 is configured inside of the modem, the invention should not be limited thereto. In some embodiments of the invention, the communication apparatus may also comprise a network card configured outside of the modem, or the communication apparatus may also be coupled to an external network card for providing Internet access services. In some embodiments of the invention, the network card 224 may be a virtual network card, instead of a tangible card, that is created by the operating system of the communication apparatus 100. Therefore, the invention should not be limited to any specific implementation method.

It should be noted that, in order to clarify the concept of the invention, FIG. 2 presents simplified block diagrams in which only the elements relevant to the invention are shown. Therefore, the invention should not be limited to what is shown in FIG. 2.

It should be further noted that in some embodiments of the invention, the modem may also comprise more than one processor and/or more than one baseband processing device. For example, the modem may comprise multiple processors and/or multiple baseband processing devices for supporting multi-RAT operations. Therefore, the invention should not be limited to what is shown in FIG. 2.

It should be further noted that in some embodiments of the invention, the baseband processing device 221 and the modem processor 222 may be integrated into one processing unit, and the modem may comprise one or multiple such processing units, for supporting multi-RAT operations. Therefore, the invention should not be limited to what is shown in FIG. 2.

According to an embodiment of the invention, the modem processor 222 and the application processor 130 may comprise a plurality of logics, each, designed for handling one or more functionalities. The logics may be configured to execute the program codes of one or more software and/or firmware modules, thereby performing the corresponding operations. When performing the corresponding operations by executing the corresponding programs, the logics may be regarded as dedicated hardware devices or circuits, such as dedicated processor sub-units. Generally, the modem processor 222 may be configured to perform operations of relative lower protocol layers while the application processor 130 may be configured to perform operations of relative higher protocol layers. Therefore, in some embodiments of the invention, the application processor 130 may be regarded as the upper layer entity or upper layer processing circuit with respect to the modem processor 222 and the modem processor 222 may be regarded as the lower layer entity or lower layer processing circuit with respect to the application processor 130.

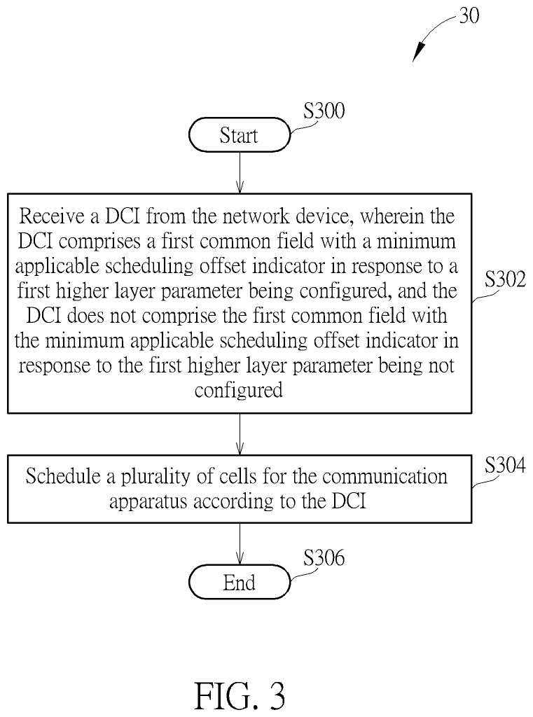

FIG. 3 is a flowchart of a process 30 utilized in a communication apparatus (e.g., the communication apparatus 100 in FIG. 1) to handle multi-cell scheduling. The process 30 comprises the following steps:
Step S300: Start.
Step S302: Receive a downlink (DL) control information (DCI) from the network device, wherein the DCI comprises a first common field with a minimum applicable scheduling offset indicator in response to a first higher layer parameter being configured, and the DCI does not comprise the first common field with the minimum applicable scheduling offset indicator in response to the first higher layer parameter being not configured.
Step S304: Schedule a plurality of cells for the communication apparatus according to the DCI.
Step S306: End.

In the process 30, the first common field with the minimum applicable scheduling offset indicator is 0 bit, if the first higher layer parameter is not configured. Otherwise, the first common field with the minimum applicable scheduling offset indicator is 1 bit. The first common field with the minimum applicable scheduling offset indicator is common control information for the plurality of cells. Therefore, the plurality of cells are co-scheduled according to a single DCI comprising the common control information. The control overhead of the communication apparatus and the decoding complexity for the DCI are reduced, and the communication apparatus decodes the DCI more easily and effectively.

Realization of the process 30 is not limited to the above description. The following embodiments of the invention may be applied to realize the process 30.

In an embodiment of the invention, the first common field is a Type-1A field. In an embodiment of the invention, the minimum applicable scheduling offset indicator is 1 bit, and the minimum applicable scheduling offset indicator with 1 bit corresponds to the plurality of cells. That is, the plurality of cells share the minimum applicable scheduling offset indicator. In an embodiment of the invention, the first higher layer parameter is minimumSchedulingOffsetKODCI-0-3 or minimumSchedulingOffsetKODCI-1-3. The first higher layer parameter minimumSchedulingOffsetKODCI-0-3 is used for an uplink (UL) transmission, and the first higher layer parameter minimumSchedulingOffsetKODCI-1-3 is used for a DL transmission. In an embodiment of the invention, the first higher layer parameter is configured by a radio resource control (RRC).

In an embodiment of the invention, a format of the DCI is DCI format 0_3 or DCI format 1_3. The DCI format 0_3 is used for an UL transmission, and the DCI format 1_3 is used for a DL transmission. In an embodiment of the invention, the DCI comprises a plurality of separate fields. In an embodiment of the invention, each of the plurality of separate fields comprises a plurality of subfields. In an embodiment of the invention, the plurality of subfields correspond to the plurality of cells, respectively (e.g., if a feature for the plurality of cells is configured).

In an embodiment of the invention, Step S306 comprises: configuring a minimum applicable scheduling offset for the plurality of cells according to the minimum applicable scheduling offset indicator, if (when) the DCI comprises the first common field with the minimum applicable scheduling offset indicator; and ignoring (e.g., not configuring) the minimum applicable scheduling offset for the plurality of cells according to the DCI, if (when) the DCI does not comprise the first common field with the minimum applicable scheduling offset indicator.

In an embodiment of the invention, the DCI comprises a second common field with a physical DL control channel (PDCCH) monitoring adaptation indication in response to a second higher layer parameter being enabled. In an embodiment of the invention, the DCI does not comprise the second common field with the PDCCH monitoring adaptation indication in response to the second higher layer parameter not being enabled. In an embodiment of the invention, the second common field with the PDCCH monitoring adaptation indication is a Type-1A field.

In an embodiment of the invention, the second higher layer parameter is pdcchMonAdaptDCI-1-3. The second higher layer parameter pdcchMonAdaptDCI-1-3 is used for a DL transmission. In an embodiment of the invention, the second higher layer parameter is configured by an RRC.

In an embodiment of the invention, the communication apparatus transmits a scheduling request for requesting the DCI to the network device, before receiving the DCI from the network device.

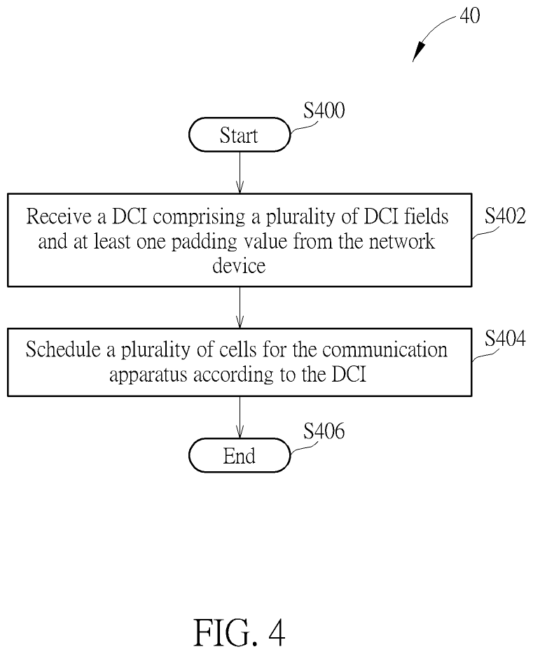

FIG. 4 is a flowchart of a process 40 utilized in a communication apparatus (e.g., the communication apparatus 100 in FIG. 1) to handle multi-cell scheduling. The process 40 comprises the following steps:
Step S400: Start.
Step S402: Receive a DCI comprising a plurality of DCI fields and at least one padding value from the network device.
Step S404: Schedule a plurality of cells for the communication apparatus according to the DCI.
Step S406: End.

In the process 40, the padding (e.g., zero-padding) is performed on the DCI or on the plurality of DCI fields in the DCI. Therefore, the plurality of cells are co-scheduled according to a single DCI with a fixed size. The control overhead of the communication apparatus and the decoding complexity for the DCI are reduced, and the communication apparatus decodes the DCI more easily and effectively.

Realization of the process 40 is not limited to the above description. The following embodiments of the invention may be applied to realize the process 40.

In an embodiment of the invention, the at least one padding value is appended (or padded) to the plurality of DCI fields in the DCI. In an embodiment of the invention, a size (or a length) of the DCI is fixed and defined in a communication standard such as 3rd generation partnership project (3GPP). That is, sufficient padding values are appended (or padded) to the end of the DCI for scheduling the plurality of cells to ensure that the size of the DCI is fixed. In an embodiment of the invention, the plurality of sizes of the plurality of DCI fields are variable (e.g., may be different).

In an embodiment of the invention, the at least one padding value comprises at least one set of padding values. In an embodiment of the invention, the at least one set of padding values is appended (or padded) to at least one end of at least one DCI field of the plurality of DCI fields, respectively. In an embodiment of the invention, each of the plurality of DCI fields has a same field size, after inserting the at least one padding value. That is, sufficient padding value (s) is appended (or padded) to the end of the DCI field in the DCI to ensure that the field sizes of the plurality of DCI fields are the same.

In an embodiment of the invention, a DCI field of the plurality of DCI fields is a common field. In an embodiment of the invention, the common field corresponds to the plurality of cells. In an embodiment of the invention, a DCI field of the plurality of DCI fields is a separate field comprising a plurality of subfields. In an embodiment of the invention, the plurality of subfields correspond to the plurality of cells, respectively (e.g., if a feature for the plurality of cells is configured). In an embodiment of the invention, the separate field is a Type-2 field.

In an embodiment of the invention, the at least one padding value comprises (e.g., is) at least one “0”. In an embodiment of the invention, a format of the DCI is DCI format 0_3 or DCI format 1_3. The DCI format 0_3 is used for an UL transmission, and the DCI format 1-3 is used for a DL transmission. In an embodiment of the invention, the DCI comprises a plurality of scheduling data (e.g., a plurality of values) corresponding the plurality of cells, respectively, when the plurality of cells are co-scheduled.

In an embodiment of the invention, the communication apparatus transmits a scheduling request for requesting the DCI to the network device, before receiving the DCI from the network device.

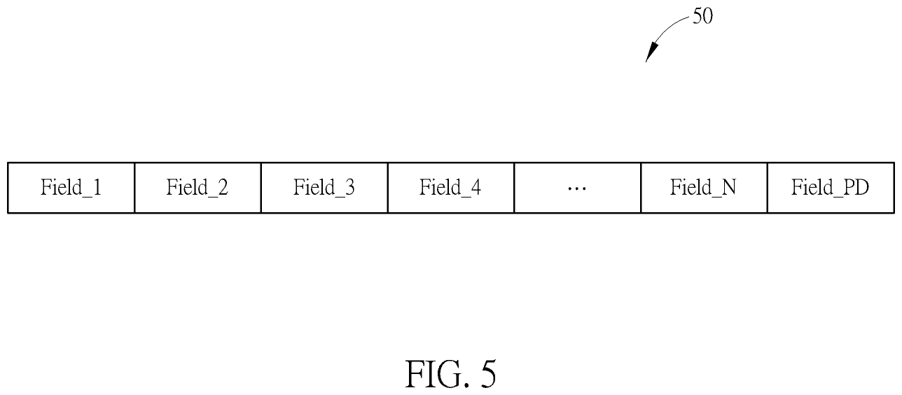

FIG. 5 is a schematic diagram of a DCI 50 according to an embodiment of the invention. The DCI 50 for multi-cells scheduling comprises DCI fields Field_1-Field N (e.g., the plurality of DCI fields in the process 40) and a padding field Field_PD (e.g., the at least one padding value in the process 40). Each of the DCI fields Field 1-Field N is a common field or a separate field, and the separate field is a Type-2 field. The DCI fields Field 1-Field_N may have different sizes, but not limited herein. The padding field Field PD comprises at least one “0”. That is, the padding field Field_PD with a variable size is appended (or padded) to an end of the DCI 50 to ensure that a size of the DCI 50 is fixed.

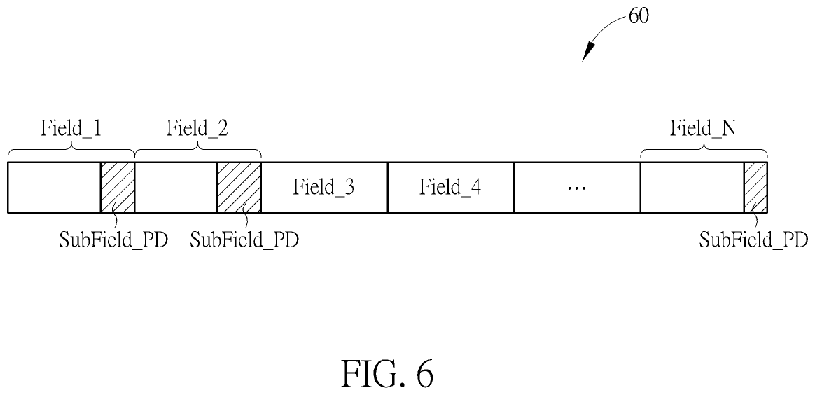

FIG. 6 is a schematic diagram of a DCI 60 according to an embodiment of the invention. The DCI 60 for multi-cells scheduling comprises DCI fields Field_1-Field N (e.g., the plurality of DCI fields in the process 40) and padding subfields SubField_PD (e.g., the at least one set of padding values in the embodiments). The padding subfields SubField_PD are represented by hatched frames. Each of the DCI fields Field_1-Field N is a common field or a separate field, and the separate field is a Type-2 field. Each of the padding subfields SubField_PD is comprised in a separate field, and comprises at least one “0”. In FIG. 6, the padding subfields SubField_PD are comprised in the DCI fields Field_1, Field_2 and Field_N. That is, the padding subfields SubField_PD with variable sizes are appended (or padded) to ends of the DCI fields Field 1, Field_2 and Field N to ensure that the field sizes of the plurality of DCI fields Field 1-Field N in the DCI 60 are the same.

To sum up, the present invention provides a communication apparatus and a method for handling multi-cell scheduling. The plurality of cells for the communication apparatus are co-scheduled according to a single DCI. The DCI may comprise a common field (a Type-1A field) with an indicator which is common control information for the plurality of cells. The padding value(s) may be appended (or padded) to the DCI to fix a size of the DCI. Therefore, the control overhead of the communication apparatus and the decoding complexity for the DCI are reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication apparatus, comprising:
a radio transceiver, transmitting or receiving wireless signals to communicate with a network device; and
a modem processor, coupled to the radio transceiver and configured to perform operations comprising:
receiving a downlink (DL) control information (DCI) from the network device, wherein the DCI comprises a common field with a minimum applicable scheduling offset indicator in response to a higher layer parameter being configured, and the DCI does not comprise the common field with the minimum applicable scheduling offset indicator in response to the higher layer parameter being not configured; and
scheduling a plurality of cells for the communication apparatus according to the DCI.

2. The communication apparatus of claim 1, wherein the common field is a Type-1A field.

3. The communication apparatus of claim 1, wherein the minimum applicable scheduling offset indicator with 1 bit corresponds to the plurality of cells.

4. The communication apparatus of claim 1, wherein the higher layer parameter is minimumSchedulingOffsetKODCI-0-3 or minimumSchedulingOffsetKODCI-1-3.

5. The communication apparatus of claim 1, wherein a format of the DCI is DCI format 0_3 or DCI format 1_3.

6. The communication apparatus of claim 1, wherein the DCI comprises a plurality of separate fields.

7. The communication apparatus of claim 6, wherein each of the plurality of separate fields comprises a plurality of subfields, and the plurality of subfields correspond to the plurality of cells, respectively.

8. The communication apparatus of claim 1, wherein the operation of scheduling the plurality of cells for the communication apparatus according to the DCI comprises:
configuring a minimum applicable scheduling offset for the plurality of cells according to the minimum applicable scheduling offset indicator, if the DCI comprises the common field with the minimum applicable scheduling offset indicator; and
ignoring the minimum applicable scheduling offset for the plurality of cells according to the DCI, if the DCI does not comprise the common field with the minimum applicable scheduling offset indicator.

9. A communication apparatus, comprising:
a radio transceiver, transmitting or receiving wireless signals to communicate with a network device; and
a modem processor, coupled to the radio transceiver and configured to perform operations comprising:
receiving a downlink (DL) control information (DCI) comprising a plurality of DCI fields and at least one padding value from the network device; and
scheduling a plurality of cells for the communication apparatus according to the DCI.

10. The communication apparatus of claim 9, wherein the at least one padding value is appended to the plurality of DCI fields in the DCI.

11. The communication apparatus of claim 9, wherein a size of the DCI is fixed and defined in a communication standard.

12. The communication apparatus of claim 9, wherein the at least one padding value comprises at least one set of padding values, and the at least one set of padding values is appended to at least one end of at least one DCI field of the plurality of DCI fields, respectively.

13. The communication apparatus of claim 9, wherein each of the plurality of DCI fields has a same field size, after inserting the at least one padding value.

14. The communication apparatus of claim 9, wherein a DCI field of the plurality of DCI fields is a common field, and the common field corresponds to the plurality of cells.

15. The communication apparatus of claim 9, wherein a DCI field of the plurality of DCI fields is a separate field comprising a plurality of subfields, and the plurality of subfields correspond to the plurality of cells, respectively.

16. The communication apparatus of claim 15, wherein the separate field is a Type-2 field.

17. The communication apparatus of claim 9, wherein the at least one padding value comprises at least one “0”.

18. The communication apparatus of claim 9, wherein a format of the DCI is DCI format 0_3 or DCI format 1_3.

19. A method for handling multi-cell scheduling, comprising:
receiving a downlink (DL) control information (DCI) from the network device, wherein the DCI comprises a common field with a minimum applicable scheduling offset indicator in response to a higher layer parameter being configured, and the DCI does not comprise the common field with the minimum applicable scheduling offset indicator in response to the higher layer parameter being not configured; and
scheduling a plurality of cells for the communication apparatus according to the DCI.

20. The communication apparatus of claim 19, wherein the common field is a Type-1A field.
